(19) United States
(12) Patent Application Publication
(10) Pub. No.: US 2005/0098706 A1
(43) Pub. Date: May 12, 2005

(54) Telescope main body and telescope

(75) Inventors: Makoto Mogamiya, Tokyo (JP); Toshio Masuda, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/981,780

(22) Filed: Nov. 5, 2004

(30) Foreign Application Priority Data
Nov. 6, 2003 (JP) 2003-377603

(51) Int. Cl. G02B 7/04

(52) U.S. Cl. 250/201.2

(57) ABSTRACT

A telescope main body, which includes an objective optical system, a focusing system, an imaging device which captures an object image, and a beam splitter. Further, the telescope main body includes a calibration system that performs a calibration operation for calibrating a position shift between an image forming position of the object image and a receiving surface of the imaging device caused by diopter variation of a user. The calibration system includes a focus driving system, a focus detecting system, and a controller. The calibration system performs the calibration operation based on a detection result by the focus detecting system in a situation where the user has achieved focusing of a visual image by manipulating a focus adjusting member.

### BACKGROUND OF THE INVENTION

The present invention relates to a telescope main body and a telescope.

A telescope (spotting scope) with a digital camera is known, which is capable of shooting an electronic image that is the same as a visual image viewed through an eyepiece thereof. Such a telescope is disclosed, for example, in a Japanese Utility Model Publication No. 3074642 (hereafter, referred to as a document 1), the disclosure of which is incorporated by reference in its entirety. The telescope with a digital camera is provided with a beam splitter for splitting a light beam that has passed through an objective optical system and a focusing lens, and leading one of the split beam to an ocular optical system and the other to an imaging device such as a CCD (charge coupled device) imaging device.

Such telescope with digital camera may incur a focal shift between a visual image viewed through the eyepiece and an object image captured by the imaging device, because of diopter variation of a user, such as hyperopia or myopia. In other words, though the image viewed through the eyepiece appears correctly focused, the image captured by the imaging device may not be correctly focused.

In order to eliminate such focal shift, a fieldscope with a DV camera disclosed in the patented document 1 is provided with a diopter adjusting ring located close to an ocular lens, to be manipulated for moving the ocular lens group such that a scale (shooting frame) marked on a focusing glass becomes clearly seen, to thereby correct a user's diopter variation, which is a variation among individuals (see paragraph 0034 of the document 1).

However, the fieldscope with a DV camera according to the document 1 still has a drawback that the manipulation of the diopter adjustment is troublesome, and the fieldscope is therefore not user-friendly. Besides, since the visual image viewed through the eyepiece can any way be focused upon manipulating a focusing ring regardless of whether the diopter adjustment is performed or not, the troublesome diopter adjustment operation is prone to be skipped or forgotten, which may result in producing a blurred picture with a focal shift.

### SUMMARY OF THE INVENTION

The present invention is advantageous in that it provides a telescope main body and a telescope, capable of calibrating without fail a focal shift caused by diopter variation of a user by easy operation, between a visual image viewed through an ocular optical system and an object image captured by an imaging device.

According to an aspect of the invention, there is provided a telescope main body, which is provided with an objective optical system, a focusing system including a focus adjusting member to be manipulated for focusing and a focusing lens which moves along a direction of an optical axis by operation of the focus adjusting member, an imaging device which captures an object image formed through the objective optical system and the focusing lens, and a beam splitter which splits an optical path through the focusing lens into a first optical path directed to the imaging device and a second optical path directed to a user's eye.

Further, the telescope main body is provided with a calibration system that performs a calibration operation for calibrating a position shift between an image forming position of the object image and a receiving surface of the imaging device caused by diopter variation of a user. The calibration system includes a focus driving system which relatively moves the image forming position of the object image with respect to the receiving surface in the direction of the optical axis, a focus detecting system which detects a status in which the image forming position of the object image coincides with the receiving surface, and a controller which controls the focus driving system. The calibration system performs the calibration operation based on a detection result by the focus detecting system in a situation where the user has achieved focusing of a visual image by manipulating the focus adjusting member.

With this configuration, the position shift focus shift between the visual image formed through the eyepiece and the object image captured by the imaging device can be cancelled and thereby properly focused images are obtained reliably.

Optionally, the telescope main body may include an operation unit which is operated by the user to enter a calibration mode in which the calibration operation is performed.

Still optionally, in the calibration mode, the calibration system may operate to notify the user to conduct the focusing of the visual image by manipulating the focus adjusting member, to receive an instruction to indicate completion of the focusing of the visual image from the user through the operation unit, and to start the calibration operation after receiving the instruction.

Still optionally, the calibration system may store calibration data regarding calibration for the position shift obtained by the calibration operation, and the calibration system may include a first operation mode in which the focus driving system is operated in accordance with the calibration data.

Still optionally, the calibration data may be stored in association with identifying data for identifying uniquely each of a plurality of users so that the first operation mode is performed differently for each of the plurality of users.

Still optionally, the telescope main body may include a focus adjusting optical system located on the second optical path.

Still optionally, the focus driving system may move the focus adjusting optical system with respect to the imaging device in a predetermined direction.

Still optionally, the imaging device may be located so that a position of the receiving surface thereof is optically equal to a target focus position of the visual image along the second optical path.

Still optionally, the position shift between the image forming position of the object image and the receiving surface of the imaging device may correspond to a focus position shift between the target focus position and an imaging forming position of the visual image caused by diopter variation of the user.

In a particular case, an imaging optical system may be formed by optical components including the objective optical system and the focusing lens and located between the objective optical system and the receiving surface of the imaging device. In this case, a focal length of the imaging optical system may be not less than 800 mm on the basis of a 35 mm film.

Optionally, the telescope main body may include an eyepiece mounting base to which an eyepiece can be detachably mounted. The eyepiece mounting base is located on the second optical path.

Still optionally, the telescope main body may include an ocular optical system located along the second optical path. In this case, the visual image is viewed through the ocular optical system.

In a particular case, the ocular optical system may be provided in an eyepiece which is fixed to the telescope main body.

In a particular case, the ocular optical system may be provided in an eyepiece which is detachably attached to the telescope main body.

According to another aspect of the invention, there is provided a telescope, which is provided with an ocular optical system, an objective optical system, a focusing system including a focus adjusting member to be manipulated for focusing and a focusing lens which moves along a direction of an optical axis by operation of the focus adjusting member, an imaging device which captures an object image formed through the objective optical system and the focusing lens, and a beam splitter which splits an optical path through the focusing lens into a first optical path directed to the imaging device and a second optical path directed to the ocular optical system.

Further, the telescope is provided with a calibration system that performs a calibration operation for calibrating a position shift between an image forming position of the object image and a receiving surface of the imaging device caused by diopter variation of a user. The calibration system includes a focus driving system which relatively moves the image forming position of the object image with respect to the receiving surface in the direction of the optical axis, a focus detecting system which detects a status in which the image forming position of the object image coincides with the receiving surface, and a controller which controls the focus driving system. The calibration system performs the calibration operation based on a detection result by the focus detecting system in a situation where the user has achieved focusing of a visual image viewed through the ocular optical system by manipulating the focus adjusting member.

With this configuration, the position shift focus shift between the visual image formed through the eyepiece and the object image captured by the imaging device can be cancelled and thereby properly focused images are obtained reliably.

### BRIEF DESCRIPTION OF THE ACCOMPANYING DRAWINGS

FIG. 1 is a perspective front view showing a telescope main body according to an embodiment of the present invention;

FIG. 2 is a perspective rear view showing the telescope main body of FIG. 1;

FIG. 3 illustrates a layout of operating buttons of the telescope main body of FIG. 1;

FIG. 4 is a cross-sectional side view showing the telescope main body of FIG. 1;

FIG. 5 is a perspective exploded view showing an optical system of a telescope according to the embodiment of the present invention;

FIG. 6 is a side view showing a prism unit viewed from an opposite side of FIG. 4;

FIG. 7 is a block diagram showing a configuration of the telescope main body of FIG. 1;

FIG. 8 is a flowchart showing a main controlling operation of the spotting scope according to the embodiment of the present invention;

FIG. 9 is a flowchart showing a menu setting subroutine; and

FIG. 10 shows transition of screen displays in the menu setting process.

### DETAILED DESCRIPTION OF THE EMBODIMENTS

Referring to the accompanying drawings, preferable embodiments of a telescope main body and a spotting scope according to the present invention will be described hereunder.

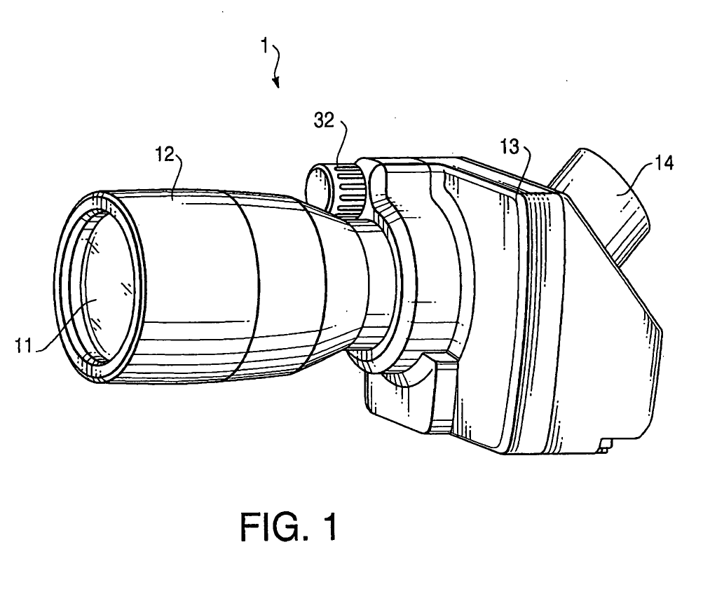

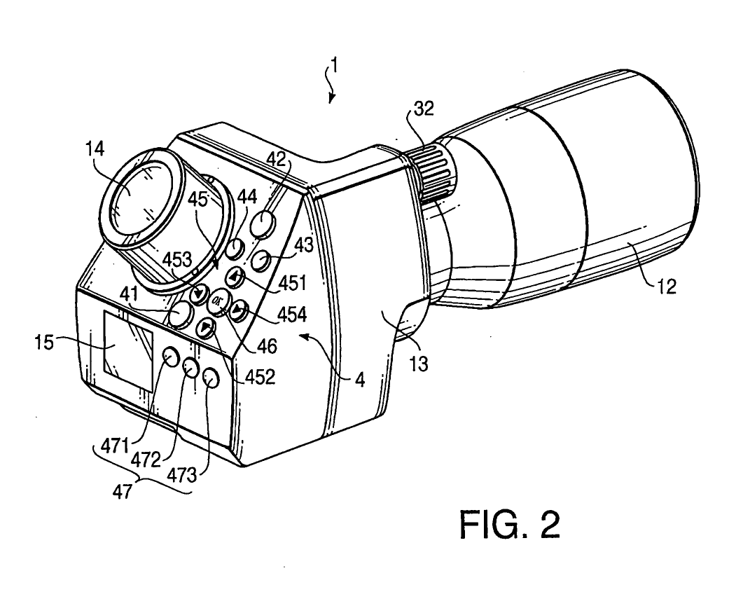

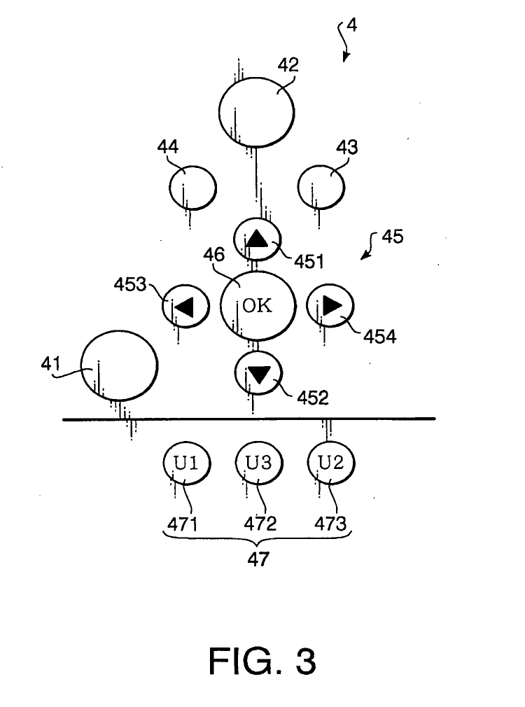

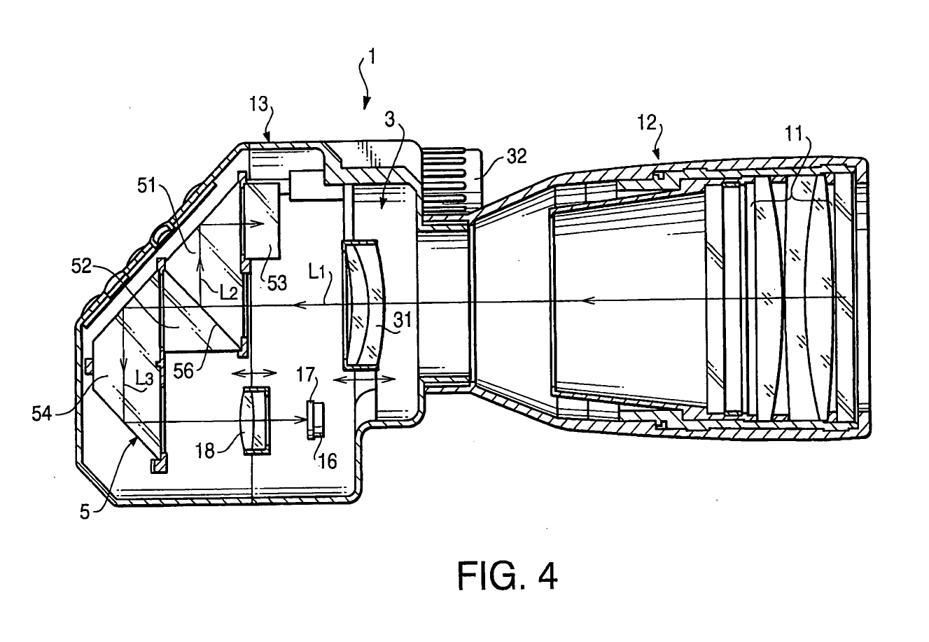

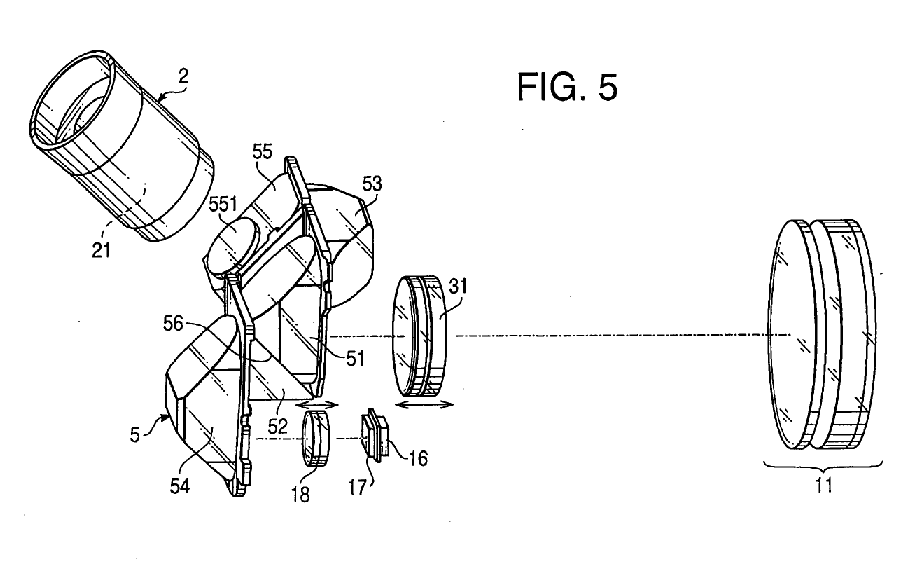

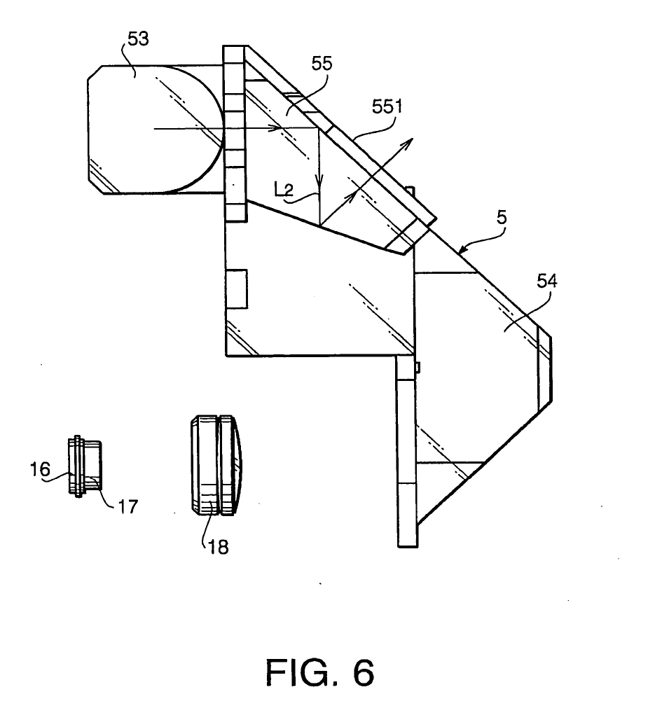

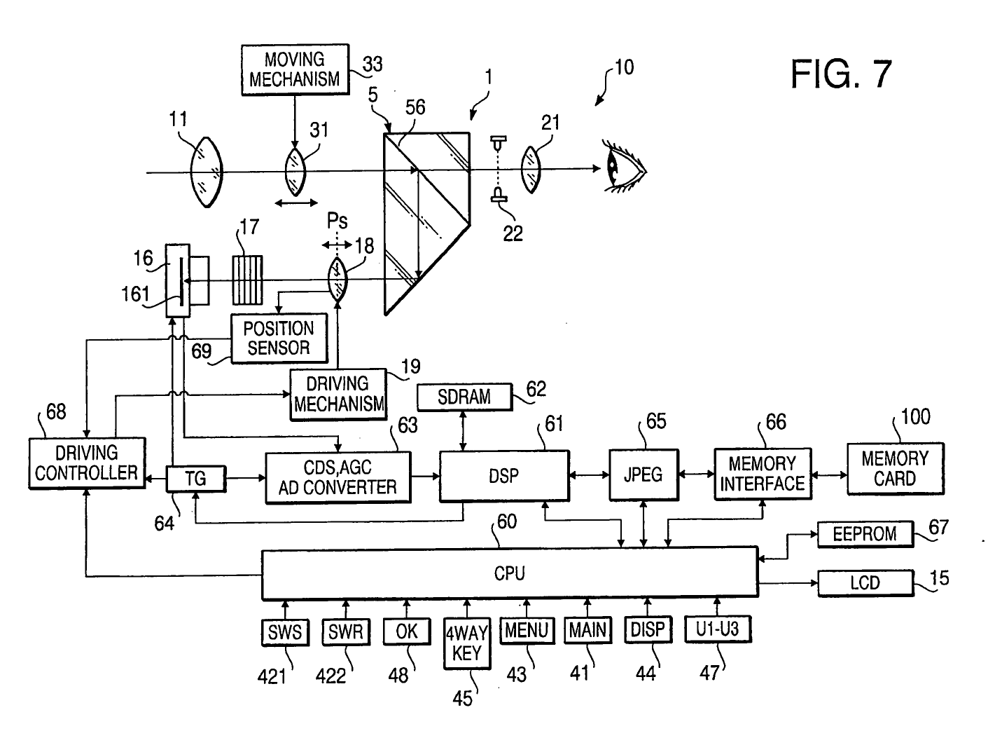

FIG. 1 is a perspective front view showing a telescope main body according to an embodiment of the present invention; FIG. 2 is a perspective rear view showing the telescope main body of FIG. 1; FIG. 3 illustrates a layout of operating buttons of the telescope main body of FIG. 1; FIG. 4 is a cross-sectional side view showing the telescope main body of FIG. 1; FIG. 5 is a perspective exploded view showing an optical system of the spotting scope according to the present invention; FIG. 6 is a side view showing a prism unit viewed from an opposite side of FIG. 4; and FIG. 7 is a block diagram showing a configuration of the telescope main body of FIG. 1.

The telescope main body 1 according to the embodiment shown in these drawings is to be combined with an eyepiece 2, to thereby constitute a spotting scope 10. The spotting scope 10 can be suitably utilized for various purposes, typically for bird watching.

As shown in FIG. 1, the telescope main body 1 is provided with a lens barrel 12 containing therein an objective optical system 11 and a casing 13 located at a base portion of the lens barrel 12. The casing 13 is provided with a focusing ring 32 rotatably disposed in an upper region of a front face thereof, for serving as a focus adjusting device.

Referring to FIG. 2, the casing 13 is provided, on a rear face thereof, with an eyepiece mounting base 14 to which the eyepiece 2 can be detachably mounted, a display panel 15 and various operating buttons 4.

On the eyepiece mounting base 14, the eyepiece 2 containing therein an ocular optical system 21 as shown in FIG. 5 can be detachably mounted. Replacing the eyepiece 2 with another having a different focal length can change a magnification of the spotting scope 10. Also, the eyepiece mounting base 14 accepts a variable focus type (zoom type) eyepiece.

While the drawings show an angle type spotting scope in which an optical axis of the eyepiece 2 mounted on the eyepiece mounting base 14 is upwardly inclined with respect to an optical axis of the objective optical system 11 by a predetermined angle, the scope of the present invention is not limited to such type. The present invention may also be applied to a straight type spotting scope in which the both optical axis are parallel to each other.

The display panel 15 is constituted of for example a liquid crystal display device. The display panel 15 can display a menu screen, a setting screen of different modes, an image captured by a CCD (Charge Coupled Device) imaging device 16 to be described later, and so forth.

Referring to FIG. 3, the operating buttons 4 include a main switch 41 for turning on and off the power, a release button 42, a menu key 43, a display key 44 for switching on and off the display panel 15, an up key 451, a down key 452, a left key 453 and a right key 454 respectively for moving a cursor displayed on the display panel 15, and an OK button 46 for entering a selected item.

The operating buttons 4 further include user identification keys 47 by which to identify a user, serving as a user identifying system. The user identification keys 47 include a U1 button 471, a U2 button 472 and a U3 button 473. The telescope main body 1 is provided with a calibration system, which calibrates a focal shift caused by diopter variation of a user between a visual image viewed through the ocular optical system 21 and an object image captured by the CCD imaging device 16, as will be subsequently described.

The calibration system is configured to store calibration data (concerning the calibration of the focal shift) with respect to a plurality of users (3 persons in this embodiment) in correlation with the U1 button 471, the U2 button 472 and the U3 button 473 respectively, so that the three persons can use the telescope main body 1 in common. Accordingly, when one of the three persons uses the telescope main body 1 in a subsequent occasion, the user can read out stored calibration data simply by pressing a button allocated to him/her among the three buttons of the user identification keys 47.

Referring to FIG. 4, the lens barrel 12 contains the objective optical system 11 in the proximity of a front end portion thereof. Also, a focusing lens (focus adjusting lens) 31 is coaxially placed with respect to the objective optical system 11, in the casing 13. The focusing lens 31 moves along a direction of the optical axis by a manipulation of the focusing ring 32, so as to adjust a focus. A focusing lens moving mechanism 33 (not shown in FIG. 4) for converting a rotational movement of the focusing ring 32 into a rectilinear movement of the focusing lens 31 may be a barrel cam mechanism or a feed screw mechanism etc. The focusing lens 31, the focusing ring 32 and the focusing lens moving mechanism 33 constitute a focusing system 3.

In the casing 13, a prism unit 5 is disposed behind the focusing lens 31. The prism unit 5 includes a first right-angle prism 51, a second right-angle prism 52, a third right-angle prism 53, a fourth right-angle prism 54 and a prism 55.

A short side surface of the first right-angle prism 51 and the long side surface of the second right-angle prism 52 are joined, and the joint plane constitutes a beam splitter 56. Also, as shown in FIG. 5, the prism 55 is provided with an emergence plane 551, through which a light beam proceeds toward the ocular optical system 21 (eyepiece mounting base 14).

Referring further to FIG. 4, a light beam that has passed through the objective optical system 11 and the focusing lens 31 first enters the first right-angle prism 51. An optical path L1 of this light beam is split at the beam splitter 56 into a first optical path L2 directed to the ocular optical system 21 and a second optical path L3 directed to the CCD imaging device 16.

The first optical path L2 directed to the ocular optical system 21 turns its direction by 180 degrees because of reflection at the beam splitter 56 as well as the other short side plane of the first right-angle prism 51. As shown in FIG. 6, the first optical path L2 is then reflected twice in the third right-angle prism 53 thus to turn its direction again by 180 degrees, and further reflected twice in the prism 55, to thereby upwardly incline and to finally proceed to the ocular optical system 21 through the emergence plane 551.

The first right-angle prism 51 and the third right-angle prism 53 constitute an erecting optical system (porro prism). For this reason an erected image can be observed through the eyepiece 2.

Back to FIG. 4, the second optical path L3 directed to the CCD imaging device 16 passes through the beam splitter 56 to enter the fourth right-angle prism 54, and is reflected twice in the fourth right-angle prism 54 to thereby turn its direction by 180 degrees and to proceed forward.

The casing 13 also accommodates therein the CCD imaging device 16, an optical filter unit 17 and a reducing optical system 18.

The CCD imaging device 16 is disposed at a position appropriate for receiving a light beam that has come along the second optical path L3, to thereby capture an image obtained through the objective optical system 11 and the focusing lens 31. As a result of such configuration, the spotting scope 10 can shoot an electronic image identical to a visual image viewed through the eyepiece 2, with the CCD imaging device 16. It should be noted that another imaging device such as a CMOS sensor or the like may be used in place of the CCD imaging device 16.

The optical filter unit 17 is attached to the CCD imaging device 16 so as to face a receiving surface 161 thereof (see FIG. 7). The optical filter unit 17 is formed by a lamination of an optical low-pass filter and an infrared cut filter. The optical low-pass filter serves to reduce a spatial frequency component close to a sampling spatial frequency determined by a pixel spacing of the CCD imaging device 16, out of a spatial frequency of a light beam of an object. The optical low-pass filter serves to prevent emergence of a moire, and the infrared cut filter serves to exclude an infrared frequency component. Providing the infrared cut filter permits preventing the CCD imaging device 16 from receiving an infrared light beam which is invisible to human eyes.

The reducing optical system 18 is placed between the fourth right-angle prism 54 and the combination of the CCD imaging device 16 and the optical filter unit 17. A light beam from the focusing lens 31 that has proceeded along the second optical path L3 is downscaled by the reducing optical system 18 so as to fit a size of the CCD imaging device 16, to thereby form an image on the receiving surface 161 of the CCD imaging device 16.

As described above, the telescope main body 1 is provided with the imaging optical system for the CCD imaging device 16, constituted of the entire optical system disposed between the objective optical system 11 to the receiving surface 161 of the CCD imaging device 16, inclusive of the former, namely the objective optical system 11, the focusing lens 31, the beam splitter 56, the reducing optical system 18 and the optical filter unit 17.

It is preferable that the imaging optical system has a focal length of not less than 800 mm on the basis of a 35 mm film. Here, a focal length on the basis of a 35 mm film means a focal length that forms an object image of a same picture angle on the receiving surface of the CCD imaging device 16, assuming that an effective receiving area of the CCD imaging device 16 is enlarged to the exposure area of a 35 mm silver halide film (36 mm×24 mm).

On the other hand, an upper limit of the focal length of the imaging optical system is not specifically determined, however from the viewpoint of a practical use, a maximum focal length of the imaging optical system of the telescope according to the embodiment of the present invention may be approx. 20000 mm on the basis of a 35 mm film.

The reducing optical system 18 is movably disposed, and is driven by a reducing optical system driving mechanism 19 so as to move in a direction of the optical axis (Ref. FIG. 7). The reducing optical system driving mechanism 19 according to the embodiment includes, though not shown in details, a feed screw and a stepping motor for rotating the feed screw, to thereby rectilinearly drive the reducing optical system 18. Operation of the reducing optical system driving mechanism 19 is controlled by a reducing optical system driving controller 68.

When the reducing optical system 18 moves in a direction of the optical axis, an image forming position of an object image formed through the objective optical system 11 and the focusing lens 31 moves with respect to the receiving surface 161 of the CCD imaging device 16, in a direction of the optical axis. Accordingly, the reducing optical system 18 serves as a focus adjusting optical system for the CCD imaging device 16, which adjusts a focus of an object image on the receiving surface 161 of the CCD imaging device 16. Likewise, the reducing optical system driving mechanism 19 serves as a focus driving system which relatively moves the image forming position of the object image with respect to the receiving surface 161 in a direction of the optical axis (i.e., the optical axis of the reducing optical system 18).

Here, the focus driving system according to the embodiment of the present invention may be constituted, without limitation to the above, so as to move the CCD imaging device 16 in a direction of the optical axis, thus to relatively move the image forming position with respect to the receiving surface 161. In this embodiment the reducing optical system 18 is moved for focus adjustment, since such design better simplifies the structure.

The reducing optical system 18 is provided with a position sensor 69 for detecting that the reducing optical system 18 is at a reference position Ps. An output signal of the position sensor 69 is input to the reducing optical system driving controller 68. When the reducing optical system 18 is at the reference position Ps, the receiving surface 161 is located at a position that is optically equivalent to a field frame 22 (target focus position) of the eyepiece 2.

Now referring to FIG. 7, from the viewpoint of electric configuration, the telescope main body 1 is provided with a CPU (Central Processing Unit) 60, a DSP (Digital Signal Processor) 61, an SDRAM (Synchronous Dynamic Random Access Memory) 62, an image signal processor 63, a timing generator 64, a JPEG circuit (image data compressor) 65, a memory interface 66, and an EEPROM (Electrically Erasable Programmable Read-Only Memory) 67. In addition, the casing 13 accommodates therein a slot (not shown) in which a memory card (storage medium) 100 can be loaded.

The CPU60 serves for integrally controlling the telescope main body 1 based on a preinstalled program and input signals from the operating buttons etc., and performs various controlling operations such as a photographic control, a control over the reducing optical system driving controller 68 and so forth.

The DSP 61 is engaged in driving control of the CCD imaging device 16 and integral control of image processing and storing, including generation of image data based on a pixel signal from the CCD imaging device 16, compression of the image data, storing the image data in the memory card 100, etc., through mutual communication with the CPU 60 for collaboration in these jobs.

The SDRAM 62 includes operating regions for image data generation etc. and regions for the display panel 15 etc., which are determined in advance.

The timing generator 64 is controlled by the DSP 61, to output a sample pulse etc. to the CCD imaging device 16, the image signal processor 63 and the reducing optical system driving controller 68, for controlling an operation thereof.

The spotting scope 10 configured as above is designed such that a visual image viewed through the eyepiece 2 is to be recognized as correctly focused when an image forming position (aerial image) of the visual image has reached a position of the field frame 22 by manipulation of the focusing ring 32, provided that the user's diopter ideally accords with a designed value. In other words, the user is expected to manipulate the focusing ring 32 for focusing purpose such that an image formed at a position of the field frame 22 (target focus position) becomes clearly seen.

As already described, since the receiving surface 161 of the CCD imaging device 16 is at a position optically equivalent to the position of the field frame 22 (target focus position) when the reducing optical system 18 is at the reference position Ps, the same object image is also formed on the receiving surface 161 of the CCD imaging device 16 once the focus is adjusted as above. Therefore, upon shooting the image under such state, a correctly focused picture is supposed to be obtained.

However, a user's diopter is different from one another, and in case of a same user also, his/her diopter varies because of eye strain, instrument myopia or depending on a condition of use (e.g., an illumination condition). Focusing capability of the user's eyes is also an issue. Accordingly, though the user recognizes that a visual image is correctly focused through the eyepiece 2, a position of the visual image formed through the focusing lens 31 may not necessarily accord with a position of the field frame 22, but may shift forward or backward from the position of the field frame 22. Naturally, a position of the object image formed by the imaging optical system also shifts from the receiving surface 161 of the CCD imaging device 16.

In the case where such shift of the image forming position of the object image exceeds a focal depth of the imaging optical system, the image captured by the CCD imaging device 16 suffers a focal shift resulting in a blurred picture, though the user believes that the image is correctly focused when viewed through the eyepiece 2.

In order to prevent such focal shift, the telescope main body 1 has the calibration system which calibrates a position shift caused by diopter variation of a user between an image forming position of an object image and the receiving surface 161. The calibration system includes the reducing optical system driving mechanism 19, the reducing optical system driving controller 68, and a focus detecting system which detects a focus on the receiving surface 161. This calibration may hereinafter be referred to as a “diopter adjustment calibration”.

Meanwhile, in this embodiment the CPU 60 serves as the focus detecting system, and detects a state in which an image forming position coincides with the receiving surface 161 by a contrast detecting method based on an output signal of the CCD imaging device 16.

Hereunder, controlling operations of the spotting scope 10 will be described, including effects and advantages of the calibration system.

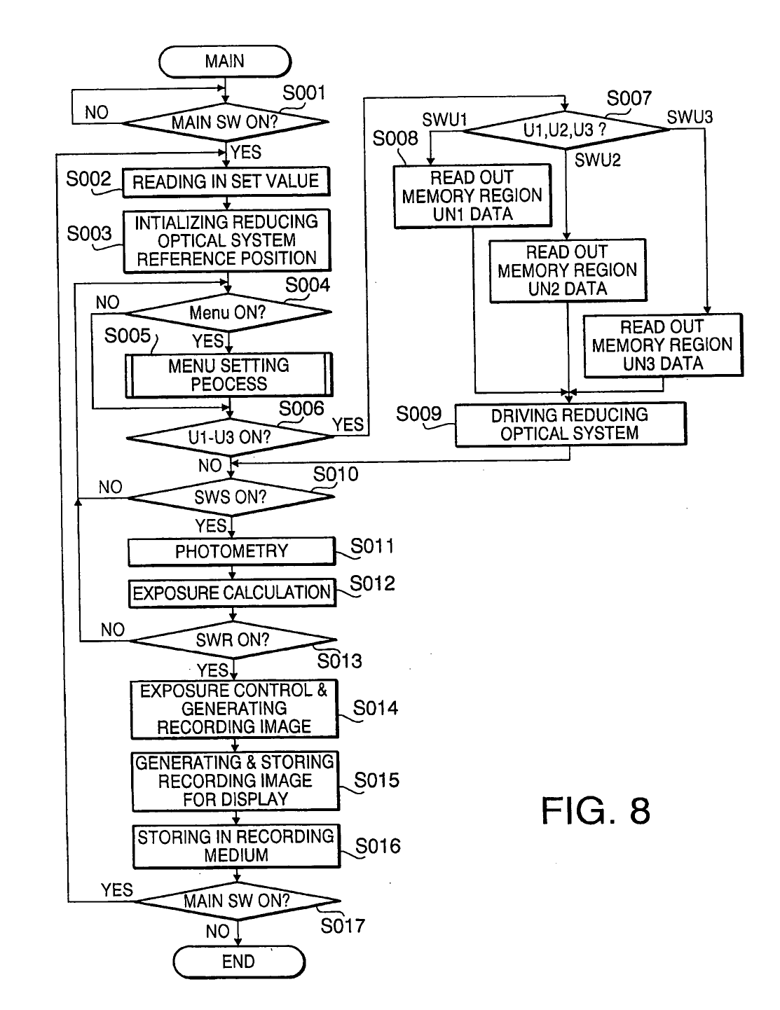

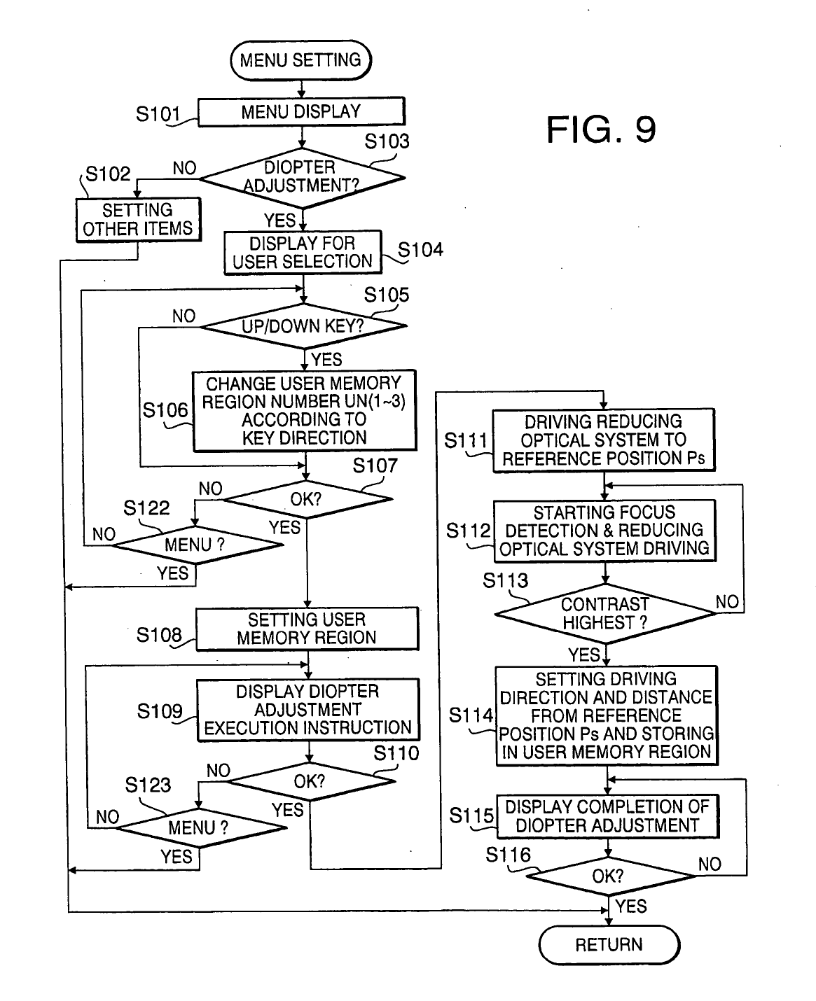

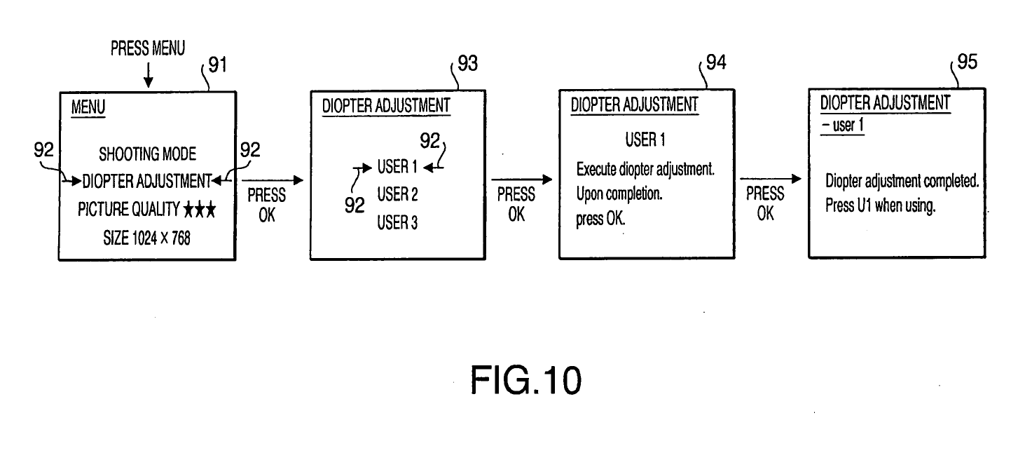

FIG. 8 is a flowchart showing a main controlling operation of the spotting scope 10 according to the embodiment; FIG. 9 is a flowchart showing a menu setting process subroutine; and FIG. 10 shows transition of screen displays in the menu setting process.

Once the main switch 41 is pressed in an off state to turn the power on (step S001 of FIG. 8), and the CPU 60 is activated and reads in various set values (step S002). The CPU 60 then drives the reducing optical system driving mechanism 19 through the reducing optical system driving controller 68, to thereby move the reducing optical system 18 to the reference position Ps (step S003), and performs the initialization.

Here, the CPU 60 controls, upon moving the reducing optical system 18, a driving direction K and a driving distance Δ so as to recognize an absolute position (actual position) of the reducing optical system 18. The driving direction K is defined as plus (+) for a predetermined direction (for example a direction separating from the CCD Imaging device 16) and minus (−) for the opposite direction, for controlling purpose. The driving distance Δ can be controlled according to the number of driving pulses provided to a stepping motor of the reducing optical system driving mechanism 19.

When performing the diopter adjustment calibration, the diopter adjustment mode (calibration mode) is to be selected. To enter the diopter adjustment mode, firstly the menu key 43 is pressed. Once the menu key 43 is pressed (step S004:YES), the following menu setting process is to be carried out (step S005).

When the menu setting process is started, the CPU 60 controls an on-screen display circuit (not shown) so as to display a main menu screen 91 shown in FIG. 10 on the display panel 15 (step S101 of FIG. 9). In the main menu screen 91, an item to be set can be selected out of “shooting mode”, “diopter adjustment”, “picture quality” and “size”, by moving the cursor 92 with either the up key 451 or the down key 452. Placing the cursor 92 on one of the letters of “shooting mode”, “picture quality” and “size” and pressing the OK button 46 leads to the setting process of the respective modes (S103:NO, S102), the description on which, however, will be omitted.

In the main menu screen 91, placing the cursor 92 on the letters of “diopter adjustment” and pressing the OK button 46 (step S103:YES) permits entering the diopter adjustment mode, and a user selecting screen 93 is displayed on the display panel 15 (step S104). In the user selecting screen 93, placing the cursor 92 on one of “user 1”, “user 2” and “user 3” and pressing the OK button 46 achieves selection of a user number, which is to be associated with calibration data (a calibration amount) at the diopter adjustment calibration to be subsequently performed.

Manipulating the up key 451 and the down key 452 in the user selecting screen 93 (step S105) causes the cursor 92 to move up and down, by which a user memory region number UN in the EEPROM 67 changes in a range of 1 to 3 (step S106). When the OK button 46 is pressed (step S107:YES), the selected user number is entered. Hereinafter, the case where the “user 1” has been selected will be described.

If it is determined in step S107 that the OK button 46 is not pressed (S107:NO), control proceeds to step S122 to judge whether or not the menu key 43 is pressed. If the menu key 43 is not pressed (S122:NO), control returns to step S105. If the menu key 43 is pressed (S107:YES), the menu setting process is terminated.

When the OK button 46 is pressed after selecting the “user 1”, a first user memory region is reserved in the EEPROM 67 under the memory region number of UN=1, for storing a calibration amount (step S108), and the display panel 15 displays a diopter adjustment execution instruction screen 94 (step S109).

The diopter adjustment execution instruction screen 94 shows a message to the effect of “Execute diopter adjustment. Upon completion, press OK button”, to urge the user to perform the diopter adjustment. Accordingly, the user manipulates the focusing ring 32 to adjust the focus of a visual image viewed through the eyepiece 2.

Once the user finishes the focus adjustment and presses the OK button 46 (step S110:YES), the diopter adjustment calibration is started (S111 through S115). If it is determined in step S110 that the OK button 46 is not pressed (S110:NO), control proceeds to step S123 to judge whether the menu key 43 is pressed. If the menu key 43 is not pressed (S123:NO), control returns to step S109. If the menu key 43 is pressed (S123:YES), the menu setting process is terminated.

In step S111, the CPU 60 drives the reducing optical system driving mechanism 19 through the reducing optical system driving controller 68 to thereby move the reducing optical system 18 to the reference position Ps (step S111), and detects a focus by a contrast detecting method (step S112).

More specifically, the CPU 60 moves the reducing optical system 18 by a minute increment, and calculates at each step a contrast value based on an image signal provided by the CCD imaging device 16, to thereby identify a position where the contrast is highest i.e. a focusing point, by a known hill climbing method (step S113). If the position having the highest contrast is detected (S113:YES), control proceeds to step S114. The detection of the position having the highest contrast is continued until the position is detected (S113:NO, S112). Thus positioning the reducing optical system 18 at such focusing point achieves correct focusing of both the visual image viewed through the eyepiece 2 and the object image captured by the CCD imaging device 16.

Then the CPU 60 stores the calibration amount in the foregoing diopter adjustment calibration, defined by a position pc of the reducing optical system 18 after the calibration, in terms of a driving direction K and a driving distance Δc from the reference position Ps, in the first user memory region in the EEPROM 67 set in the step S108 (step S114). Also, the CPU 60 displays a diopter adjustment completion screen 96 on the display panel 15 to announce to the user that registration of the calibration amount has been completed (step S115). Pressing the OK button 46 here finishes the diopter adjustment mode (step S116:YES). If the OK button 46 is not pressed (S116:NO), control returns to step S115.

While the foregoing description refers to the case of performing the diopter adjustment calibration with respect to the “user 1” and registering (storing) the calibration amount, the diopter adjustment calibration and the registration of the calibration amount can equally be performed with respect to the “user 2” and the “user 3”. Accordingly, the calibration amount can be registered with respect to up to three persons in this embodiment.

When a user who has finished the diopter adjustment calibration is going to use the spotting scope 10, the user can identify him/herself by pressing a button of the corresponding number among the user identification keys 47 (step S006 of FIG. 8). If the identification key 47 are not pressed (S006:NO), control proceeds to step S010.

In the following passages, the case of the “user 1”will be described as a representative example. When the U1 button 471 is pressed (S006:YES, S007:SWU1), the CPU 60 reads out data of the calibration data stored in the first user memory region in the EEPROM 67 (S008), and moves the reducing optical system 18 to a calibration point defined by the calibration data (S009). Then, control proceeds to step S010.

Thereafter, the “user 1” looks into the eyepiece 2 for viewing an image. At this stage, the user can adjust a focus of the visual image by manipulating the focusing ring 32 according to a distance of the object.

On the display panel 15, a live view (monitor display) of a real-time image captured by the CCD imaging device 16, which is the same as the visual image, is displayed as described in the following process. The object image formed on the receiving surface 161 of the CCD imaging device 16 is photoelectrically converted into electrical charge data, and such charge data (signal) is sequentially read out from the CCD imaging device 16 with a portion corresponding to a predetermined number of pixels thinned out, for reproducing a live view image.

Further, the signal undergoes a correlative double sampling (CDS), automatic gain control (AGC) and analog/digital conversion in the imaging signal processor 63, to then be input to the DSP 61. In the DSP 61, a predetermined signal processing including color processing and gamma correction etc. is performed on the input signal, to thereby generate a live view image data (luminosity signal Y, two color difference signals Cr, Cb).

The live view image data includes a fewer number of pixels (because of the thinning out) than the number of effective pixels of the CCD imaging device 16, in accordance with the number of pixels of the display panel 15, so that the display panel can display an image according to such live view image data. The generation of the live view image data is periodically updated each time the data is read out from the CCD imaging device 16, so that the image is displayed on the display panel 15 as a real-time motion picture.

In step S010, it is judged whether the release button 42 is pressed by half. When the release button 42 is pressed by half and thereby a photometric switch 421 is tuned on (S011:YES), the CPU60 performs photometry (step S011) and exposure calculation (step S012) based on an output signal from the CCD imaging device 16. If it is determined that the photometry switch 421 is not turned on (S010:NO), control returns to step S004.

When the release button 42 is pressed all the way down and a release switch 422 is thereby turned on (step S013:YES), the CPU 60 instructs the DSP 61 to execute a real exposure. The DSP 61, upon receipt of the instruction of a real exposure, performs unwanted charge discharging control and exposure control (charge storage time control) etc. for the CCD imaging device 16, and then reads out charge data through the imaging signal processor 63 as described earlier, from the CCD imaging device 16 without thinning out the pixels and temporarily stores the data in the SDRAM 62.

Then the DSP 61 carries out a predetermined signal processing with respect to the charge data read out of the SDRAM 62, to thereby generate an original still image data for recording, constituted of the full number of pixels (step S014). If it is determined that the release switch 422 is not turned on (S013:NO), control returns to step S004.

Further, the DSP 61 thins out the pixels from the generated original still image data for recording to generate a screen nail of a still image for displaying (for example 640×480 pixels), and displays the screen nail on the display panel 15 for a predetermined period of time (step S015). The DSP 61 also compresses the generated original still image data for recording in the JPEG circuit 65, and outputs the compressed image data through the memory interface 66, so that the compressed image data is stored in the memory card 100 (step S016). When the main switch 41 is pressed again and thereby the power is turned off (S017:NO), the main controlling operation is terminated. When the main switch is ON (S017:YES), control returns to step S002.

As described according to the embodiment, the focus shift between the visual image formed through the eyepiece 2 and the object image captured by the CCD imaging device 16 can be cancelled and thereby properly focused images are obtained reliably.

Such an advantage of the embodiment is enhanced when the imaging optical system has a relatively long focal length (e.g., a focal length of more than 800 mm).

Although the telescope main body and the spotting scope according to the present invention have been described referring to the embodiment shown in the accompanying drawings, it is to be understood that the present invention is not limited to the foregoing embodiment, and that the constituents of the telescope main body and the spotting scope may be optionally substituted with different ones which have an equivalent function. Also, an additional constituent may be optionally incorporated.

After the diopter adjustment calibration is finished, when a visual image formed through the eyepiece 2 is focused by use of the focusing ring 32 by the user, an object image is also properly focused on the receiving surface 116 of the CCD imaging device 16 regardless of object distance. Therefore, it is not necessary to drive the reducing optical system after the diopter adjustment calibration is finished. Accordingly, time lag for focus adjustment can be reduced and thereby likelihood of missing a shooting chance is minimized.

The user can easily instruct the telescope main body 1 to perform the diopter adjustment calibration by only pressing the user identification keys 47, by which the usability can be enhanced.

Further, while the contrast detecting method is employed as the focus detecting system in the foregoing embodiment, the focus detecting system may be constituted of a different method, for example a phase shift detecting method. Further, while the spotting scope 10 according to the foregoing embodiment is provided with the eyepiece 2 which can be detachably attached to the telescope main body 1 and is hence interchangeable, the eyepiece may be integrally installed on the telescope main body thus to disable an interchange.

Furthermore, the present invention can be applied to various other types of telescopes including an astronomical telescope, without limitation to a spotting scope.

The present disclosure relates to the subject matter contained in Japanese Patent Application No. 2003-377603, filed on Nov. 6, 2003, which is expressly incorporated herein by reference in its entirety.

1. A telescope main body, comprising:
an objective optical system;
a focusing system including a focus adjusting member to be manipulated for focusing and a focusing lens which moves along a direction of an optical axis by operation of the focus adjusting member;
an imaging device which captures an object image formed through the objective optical system and the focusing lens;
a beam splitter which splits an optical path through the focusing lens into a first optical path directed to the imaging device and a second optical path directed to a user's eye; and
a calibration system that performs a calibration operation for calibrating a position shift between an image forming position of the object image and a receiving surface of the imaging device caused by diopter variation of a user,
wherein the calibration system includes:
a focus driving system which relatively moves the image forming position of the object image with respect to the receiving surface in the direction of the optical axis;
a focus detecting system which detects a status in which the image forming position of the object image coincides with the receiving surface; and
a controller which controls the focus driving system,
wherein the calibration system performs the calibration operation based on a detection result by the focus detecting system in a situation where the user has achieved focusing of a visual image by manipulating the focus adjusting member.

2. The telescope main body according to claim 1, further comprising an operation unit which is operated by the user to enter a calibration mode in which the calibration operation is performed.

3. The telescope main body according to claim 2, wherein, in the calibration mode, the calibration system operates to notify the user to conduct the focusing of the visual image by manipulating the focus adjusting member, to receive an instruction to indicate completion of the focusing of the visual image from the user through the operation unit, and to start the calibration operation after receiving the instruction.

4. The telescope main body according to claim 1,
wherein the calibration system stores calibration data regarding calibration for the position shift obtained by the calibration operation, and
wherein the calibration system includes a first operation mode in which the focus driving system is operated in accordance with the calibration data.

5. The telescope main body according to claim 4, wherein the calibration data is stored in association with identifying data for identifying uniquely each of a plurality of users so that the first operation mode is performed differently for each of the plurality of users.

6. The telescope main body according to claim 1, further comprising a focus adjusting optical system located on the second optical path.

7. The telescope main body according to claim 6, wherein the focus driving system moves the focus adjusting optical system with respect to the imaging device in a predetermined direction.

8. The telescope main body according to claim 1, wherein the imaging device is located so that a position of the receiving surface thereof is optically equal to a target focus position of the visual image along the second optical path.

9. The telescope main body according to claim 8, wherein the position shift between the image forming position of the object image and the receiving surface of the imaging device corresponds to a focus position shift between the target focus position and a imaging forming position of the visual image caused by diopter variation of the user.

10. The telescope main body according to claim 1,
wherein an imaging optical system is formed by optical components including the objective optical system and the focusing lens and located between the objective optical system and the receiving surface of the imaging device, and
wherein a focal length of the imaging optical system is not less than 800 mm on the basis of a 35 mm film.

11. The telescope main body according to claim 1, further comprising an eyepiece mounting base to which an eyepiece can be detachably mounted, the eyepiece mounting base being located on the second optical path.

12. The telescope main body according to claim 1, further comprising an ocular optical system located along the second optical path,
wherein the visual image is viewed through the ocular optical system.

13. The telescope main body according to claim 12, wherein the ocular optical system is provided in an eyepiece which is fixed to the telescope main body.

14. The telescope main body according to claim 12, wherein the ocular optical system is provided in an eyepiece which is detachably attached to the telescope main body.

15. A telescope, comprising:
an ocular optical system;
an objective optical system;
a focusing system including a focus adjusting member to be manipulated for focusing and a focusing lens which moves along a direction of an optical axis by operation of the focus adjusting member;
an imaging device which captures an object image formed through the objective optical system and the focusing lens;
a beam splitter which splits an optical path through the focusing lens into a first optical path directed to the imaging device and a second optical path directed to the ocular optical system; and
a calibration system that performs a calibration operation for calibrating a position shift between an image forming position of the object image and a receiving surface of the imaging device caused by diopter variation of a user,
wherein the calibration system includes:
a focus driving system which relatively moves the image forming position of the object image with respect to the receiving surface in the direction of the optical axis;
a focus detecting system which detects a status in which the image forming position of the object image coincides with the receiving surface; and
a controller which controls the focus driving system,
wherein the calibration system performs the calibration operation based on a detection result by the focus detecting system in a situation where the user has achieved focusing of a visual image viewed through the ocular optical system by manipulating the focus adjusting member.
